(19) United States
(12) Patent Application Publication
(10) Pub. No.: US 2005/0276258 A1
(43) Pub. Date: Dec. 15, 2005

(54) Method and arrangement for uplink scheduling

(76) Inventor: Jian Gu, Huangqi Nanhai (CN)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/899,299

(22) Filed: Jul. 27, 2004

(30) Foreign Application Priority Data
May 27, 2004 (FI) 20045195

(51) Int. Cl. H04L 12/26

(52) U.S. Cl. 370/349

(57) ABSTRACT

A mobile communication network including at least one base station for supporting at least one uplink data connection of at least one terminal that is in the audibility area of the base station, means for forming a quality target for the uplink connection of the terminal. The network comprises means for estimating load of a network element by applying the formed quality target, and means for scheduling uplink data packets to be sent by the at least one terminal by monitoring that the estimated load does not exceed a predetermined load threshold of the network element.

### FIELD OF THE INVENTION

The present invention relates to an uplink scheduling method in a mobile packet data network. The invention also relates to a mobile packet data network performing uplink scheduling.

### BACKGROUND OF THE INVENTION

Data packet scheduling is an algorithm in a wireless communication network to determine which non real time data users are allowed to transmit over the radio interface and how radio resources are allocated among non real time data users that are using services, such as web browsing and a short message service.

A goal of the packet scheduling algorithm can be, for instance, to aim in fair throughput by giving all users the same throughput. Other criteria that can be used include fairness of transmission time or prioritization according to the quality of transmission links. The algorithm has functions such as dividing air capacity among the users, deciding the transport channels to be used by each user and monitoring packet allocations and the system load.

In prior art, when scheduling uplink data packets and thereby estimating the load level of network elements, the measured Signal to Interference plus Noise Ratios (SINR) of different links have been used. However, the usage of the measured SINR is disadvantageous due to the variation of a fading channel, which makes the prior art load estimation inaccurate.

Hybrid Automatic Repeat reQuest (HARQ) is an important technique to increase the throughput of wireless packet data communication systems that support high data rates. In HARQ, if a receiver receives a frame correctly, it feeds back an ACK to the transmitter. Otherwise, the receiver feeds back a NAK and stores the received signal. If the transmitter receives an ACK, a retransmission is unnecessary but if the transmitter receives a NAK, it retransmits the frame. The receiver then receives the retransmitted frame and soft-combines the retransmitted symbols with the symbols that were received in the original message and stored in the receiver. Such soft-combining greatly reduces the error rate of retransmissions and increases the system throughput.

The disadvantage of the prior art becomes further emphasized due to the inherent features of HARQ, that is, retransmission would not necessarily need as a high SIR as set for the initial transmissions. Therefore, in the prior art, load estimation has been inaccurate, causing inefficient utilization of uplink resources and degradation of the system performance.

### BRIEF DESCRIPTION OF THE INVENTION

It is thus an object of the invention to overcome drawbacks of the prior art and to provide a new scheduling method to increase system throughput.

In one aspect of the invention, there is provided an uplink scheduling method in a mobile communication network, wherein at least one mobile terminal has at least one uplink packet data connection with the network, the method comprising forming a quality target for each uplink connection. The method comprises the step of estimating load of a network element by applying the formed quality target, scheduling uplink data packets to be sent by the at least one terminal by monitoring that the estimated load does not exceed a predetermined load threshold of the network element.

In one aspect of the invention, there is provided a mobile communication network, including at least one base station for supporting at least one uplink packet data connection of at least one terminal that is in the audibility area of the base station, means for forming a quality target for each uplink connection. The network comprises means for estimating load of a network element by applying the formed quality target, and means for scheduling uplink data packets to be sent by the at least one terminal by monitoring that the estimated load does not exceed a predetermined load threshold of the network element.

The invention thus relates to uplink scheduling of data packets in a mobile communication network. The mobile communication network according to the invention covers all networks capable of handling data transmission. An example of such a network is the Universal Mobile Communications Network (UMTS). Terminals having a data transmission connection with the network can be mobile phones or other terminals adapted to have a bi-directional data transmission connection with the network.

In one embodiment of the invention, quality of a connection is measured in conjunction with a closed loop power control algorithm applied in the network, the closed loop power control algorithm including an inner and an outer loop power control. The quality of a connection can be estimated in several ways, such as by estimating SIR (a ratio of the signal power to the interference power), E_{b}/N₀ (a ratio of the combined received energy per information bit to the noise power spectral density), E_{b}/Nₜ (a ratio of the combined received energy per information bit to the effective noise power spectral density), E_{c}/I₀ (a ratio of the pilot energy accumulated over one PN chip period to the total power spectral density in the received bandwidth) and C/I (a ratio of the carrier power to the interference power). Connection quality can be estimated in many other ways and the invention is thus not restricted to the given examples. In the following disclosure, SIR has been mainly used as an example of a quality estimate.

An outer loop power control sets a quality target, such as a SIR target, for instance. The inner loop power control then determines, based on the SIR target and the received SIR, whether the transmit power should be increased or decreased. It is important for the system performance to set an appropriate value for the SIR target, thereby enabling capacity of interference-limited communication systems to be increased.

In the invention, quality target values are applied when determining a suitable load level of a network, thereby providing advantages for scheduling of data packets.

An advantage of the method and arrangement of the invention is that it enhances utilization of network resources. A quality target represents the most appropriate and most timely piece of information on the conditions on a radio link, and thereby load of the network can be estimated in a very reliable manner.

### BRIEF DESCRIPTION OF THE DRAWINGS

In the following, the invention will be described in greater detail by means of preferred embodiments and with reference to the accompanying drawings, in which

FIG. 1 illustrates one embodiment of a method according to the invention;

FIG. 2 illustrates another embodiment of the method according to the invention;

FIG. 3 discloses one embodiment of an arrangement according to the invention, and

FIG. 4 discloses another embodiment of an arrangement according to the invention.

### DETAILED DESCRIPTION OF THE INVENTION

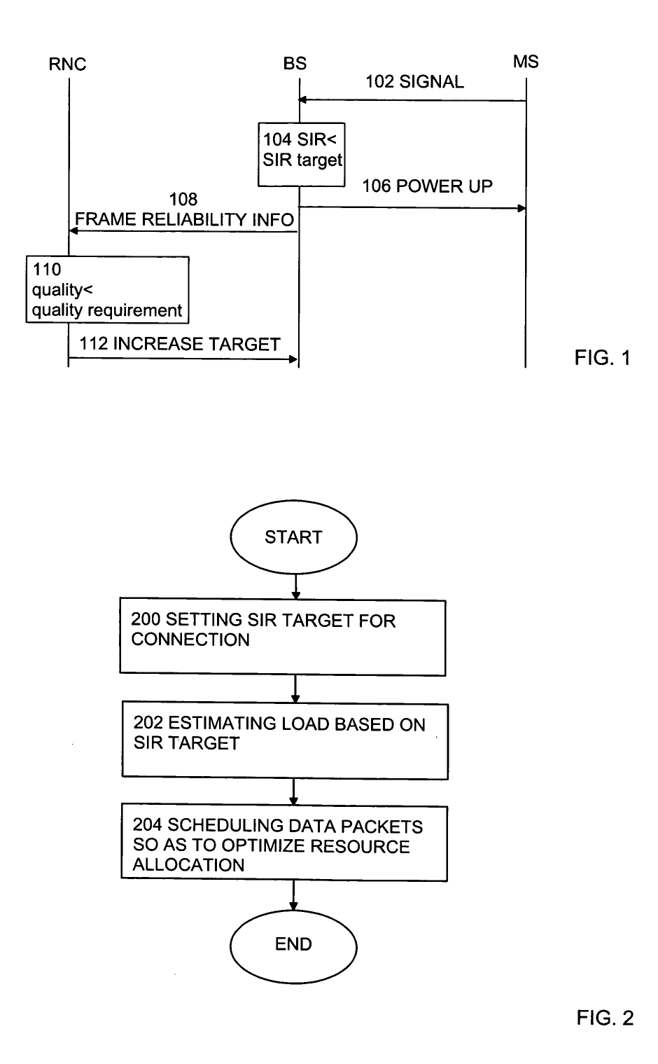

FIG. 1 is shows one embodiment of a method according to the invention. At first, it is assumed that there is a number of terminals within the operating area of a network. The network includes a number of base stations or Node B's, each having a certain operating area, that is, a cell. Cells partly overlapping each other thereby form a cellular network having a certain coverage area. A terminal in the operating area of the network may simultaneously have a connection to one or more base stations simultaneously. A situation wherein a terminal has a connection with two or more cells is called soft handover. Base stations participating in soft handover for a connection form an active set for the connection.

Typically, base stations are controlled by a base station controller (BSC) or a radio network controller (RNC). RNC or BSC is a network element level that is capable of estimating load in base stations. During a connection, a base station can send measurement reports, such as reports from the signal to interference ratio, to RNC. RNC can then set a SIR target for the connection. Instead of RNC (or BSC), a quality target for a connection can also be set in a base station, for instance.

RNC is aware of the number of connections in the base station and data rates used in the connections, and thereby RNC has all the information needed to estimate load in a base station. RNC can thereby also control the scheduling of data packets that are to be received by base stations on the uplink. Alternatively, each base station itself can be responsible for its scheduling or rate control, because it has timely link and HARQ information.

In a radio network, such as UMTS, it is essential to use a power control mechanism, which is illustrated by FIG. 1. Without efficient power control, a single terminal using too high a power level could block a whole cell. Basically, the power control problem has been solved so that on the uplink, the received power level from all terminals is on a desired level. The desired power levels can vary from user to user due to different data rates of the users, different QoS requirements and different environments. In UMTS applying WCDMA (Wideband Code Division Multiple Access), a fast closed-loop power control mechanism is utilized. In a closed-loop power control on the uplink, a base station frequently estimates a received SIR value of the received signal in step 102 and compares it to a SIR target according to step 104. If the measured SIR is higher than the target SIR, the base station commands the mobile station to lower the power, if it is too low the mobile is commanded to increase its power as shown in step 106. Such a procedure can be implemented 1500 times per second, for instance, for each terminal. In an outer loop power control mechanism, a base station transmits frame reliability information in step 108 to a radio network controller and, as shown in step 110, if a need exists, SIR target is adjusted according to the quality requirement of a particular terminal as shown in step 112. Outer loop power control is performed in RNC so as to enable a soft handover combining. Alternatively, outer loop power control can be performed in a base station so as to utilize the latest link and HARQ information. In soft handover, the terminal has to decide which power control commands to take into account when receiving such commands from multiple sources. Practically, a terminal makes decisions by listening to all such commands but by possibly additionally estimating the reliability of each command.

FIG. 2 illustrates one embodiment of the method according to the invention, starting from step 200 setting a SIR target for a connection. Step 202 illustrates load estimation in the network by using the SIR target set in the network, for instance, in RNC or a base station. The load of the j^{th} cell that is caused by the i^{th} user with the data rate of Rᵢ can be estimated at a given time by formula (1).

$${Load}_{j} = {\sum }_{j ∈ ActiveSet ( i )} \frac{Sin {rT}_{i , j} ( {R}_{i} ) \cdot ( 1 + {\sum }_{l ∈ all other channels} {PT}_{i , l} ( {R}_{i} ) )}{1 + Sin {rT}_{i , j} ( {R}_{i} ) \cdot ( 1 + {\sum }_{l ∈ all other channels} {PT}_{i , j} ( {R}_{i} ) )} , \qquad ( 1 )$$

where SinrT_{i,j}(Rᵢ) is the pilot channel SINR target of the j^{th} cell of the i^{th} user with the data rate of Rᵢ at the given time. When estimating load, one can consider whether the scheduled packet is a HARQ retransmission packet of the i^{th} user. If the scheduled packet is a HARQ retransmission packet of the i^{th} user, the value of SinrT_{i,j}(Rᵢ) then depends on the SIR target of the packet's initial transmission, the number of retransmissions or other available information. Otherwise, SinrT_{i,j}(Rᵢ) can be the SIR target for the initial transmission. Additionally, in formula (1), PT_{i,j}(Rᵢ) is the i^{th} user's power ratio of the l^{th} channel to the traffic channel whose SIR target is SinrT_{i,j}(Rᵢ). Besides a pilot channel, the SIR target can also be based on an uplink traffic channel or other channels.

In a mobile network, several scheduling algorithms can be used. In one embodiment, the available capacity in the network is determined as shown by formula (2). Let a load constraint be Loadⱼ≦max Load. The available capacity C_{available} is decreased by the usage of pilots or autonomous transmissions, and the estimate of the scheduled rates Rₑₛₜ of the terminals in soft handover for which the base station is not the serving and therefore not the scheduling base station.

$${C}_{available} ( j ) = max Load - {\sum }_{i} {\sum }_{{j ∈ AS ( i )}_{j ∉ Serving ( i )}} \frac{\begin{matrix}Sin {rT}_{i , j} ( max ( 0 , {R}_{min TFC} ) ) \cdot \\ ( 1 + {\sum }_{ l } {PT}_{i , l} ( max ( 0 , {R}_{min TFC} ) ) )\end{matrix}}{\begin{matrix}1 + Sin {rT}_{i , j} ( max ( 0 , {R}_{min TFC} ) ) \cdot \\ ( 1 + {\sum }_{l} {PT}_{i , l} ( max ( 0 , {R}_{min TFC} ) ) )\end{matrix}} - {\sum }_{i} {\sum }_{{j ∈ AS ( i )}_{j ∈ Serving ( i )}} \frac{Sin {rT}_{i , j} ( {R}_{est} ) \cdot ( 1 + {\sum }_{ l } {PT}_{i , l} ( {R}_{est} ) )}{1 + Sin {rT}_{i , j} ( {R}_{est} ) \cdot ( 1 + {\sum }_{l} {PT}_{i , l} ( {R}_{est} ) )} \qquad ( 2 )$$

where max Load is the maximum load, AS(i) is the active set of the i^{th} terminal, serving(i) is the serving base station of the i^{th} terminal and l belongs to the set of all other channels. R_{minTFC} is the minimum TFC in the TFCS, which is used in automatic transmission. When resources taken in a non-serving base station from a terminal in soft handover are computed, one approach is to account for the rate that has been transmitted in the terminal's previous HARQ process. It will be obvious to a person skilled in the art that as the technology advances, other approaches to estimating resources taken in a non-serving base station can be utilized in the invention.

As illustrated in step 204, data packets are scheduled so as to optimize resource allocation. In one embodiment this means that throughput, that is, the total amount of data transmitted on the uplink in the network, and fairness are optimized.

The scheduling algorithm has two major characteristics, that is, prioritization of UE requests and greedy filling for maximum capacity utilization. The highest priority terminal is allowed to transmit first, successively followed by lower priority terminals. The terminals are assigned the maximum Transport Format Combination (TFC) allowed in TFC Set (TFCS) based on its request and available capacity.

In the scheduling algorithm, the terminal requests are prioritized according to a priority function, which is set to 0 in the beginning of the simulation. When a new terminal enters the system into cell j as the primary cell, or its buffer becomes non-empty after being idle due to a lack of data, its priority function is set to minimum priority. In the algorithm, the value of k is first set to 1 and the terminal at the k^{th} position in the queue is assigned the rate Rₖ given by formula (3):

$${R}_{k} = min \{ {R}_{max}^{k} ( s ) , arg {max}_{R} [ \begin{matrix}R \vert {C}_{available} ( j ) - \frac{Sin {rT}_{k , j} ( R ) \cdot ( 1 + {\sum }_{ l } {PT}_{k , l} ( R ) )}{1 + Sin {rT}_{k , j} ( R ) \cdot ( 1 + {\sum }_{l} {PT}_{k , l} ( R ) )} + \\ \frac{\begin{matrix}Sin {rT}_{k , j} ( max ( 0 , {R}_{min TFC} ) ) \cdot \\ ( 1 + {\sum }_{ l } {PT}_{k , l} ( max ( 0 , {R}_{min TFC} ) ) )\end{matrix}}{\begin{matrix}1 + Sin {rT}_{k , j} ( max ( 0 , {R}_{min TFC} ) ) \cdot \\ ( 1 + {\sum }_{l} {PT}_{k , l} ( max ( 0 , {R}_{min TFC} ) ) )\end{matrix}} \geq 0 ; \\ j is the serving base station\end{matrix} ] \} \qquad ( 3 )$$

where Rₘₐₓ^{k}(s) is the allowed maximum TFC of the k^{th} UE.

If the scheduling is for a HARQ process, the scheduler assigns the rate Rₖ as determined above if there is no retransmission. If the transmission is a retransmission, Rₖ can be set to the corresponding previous transmission or a new transmission rate can be selected. The available capacity is then updated to the form illustrated by formula (4).

$${C}_{available} ( j ) = {C}_{available} ( j ) - \frac{Sin {rT}_{k , j} ( {R}_{k} ) \cdot ( 1 + {\sum }_{ l } {PT}_{k , l} ( {R}_{k} ) )}{1 + Sin {rT}_{k , j} ( {R}_{k} ) \cdot ( 1 + {\sum }_{l} {PT}_{k , l} ( {R}_{k} ) )} + \frac{\begin{matrix}Sin {rT}_{k , j} ( max ( 0 , {R}_{min TFC} ) ) \cdot \\ ( 1 + {\sum }_{ l } {PT}_{k , l} ( max ( 0 , {R}_{min TFC} ) ) )\end{matrix}}{\begin{matrix}1 + Sin {rT}_{k , j} ( max ( 0 , {R}_{min TFC} ) ) \cdot \\ ( 1 + {\sum }_{l} {PT}_{k , l} ( max ( 0 , {R}_{min TFC} ) ) )\end{matrix}} \qquad ( 4 )$$

j is the serving base station

A new priority function value is then calculated and k is incremented. If k<the total number of user equipment in the list, the method is repeated, otherwise it is stopped.

In addition to the above-disclosed scheduling method, the resources of the base station can be allocated by using an algorithm called rate control algorithm. Thereby, when the load has been estimated with a sufficient accuracy, uplink data packets can be scheduled in a more optimal manner in the network.

In one embodiment, the available capacity in the network is determined as shown by formula (5). Let a load constraint be Loadⱼ≦max Load. The available capacity C_{available} is decreased by the usage of pilots or autonomous transmissions, and the estimate of the scheduled rates Rₑₛₜ of the terminals in soft handover for which the base station is not the serving and therefore not the rate controlling base station.

$${C}_{available} ( j ) = max Load - {\sum }_{i} {\sum }_{{j ∈ AS ( i )}_{j ∈ rateCtrl ( i )}} \frac{\begin{matrix}Sin {rT}_{i , j} ( {R}_{red } ( i ) ) \cdot \\ ( 1 + {\sum }_{ l } {PT}_{i , l} ( {R}_{red } ( i ) ) )\end{matrix}}{\begin{matrix}1 + Sin {rT}_{i , j} {R}_{red } ( i ) ) \cdot \\ ( 1 + {\sum }_{l} {PT}_{i , l} ( {R}_{red } ( i ) ) )\end{matrix}} - {\sum }_{i} {\sum }_{{j ∈ AS ( i )}_{j ∉ rateCtrl ( i )}} \frac{Sin {rT}_{i , j} ( {R}_{est} ) \cdot ( 1 + {\sum }_{ l } {PT}_{i , l} ( {R}_{est} ) )}{1 + Sin {rT}_{i , j} ( {R}_{est} ) \cdot ( 1 + {\sum }_{l} {PT}_{i , l} ( {R}_{est} ) )} \qquad ( 5 )$$

where max Load is the maximum load, AS(i) is the active set of the i^{th} terminal, serving(i) is the serving base station of the i^{th} terminal and l belongs to the set of all other channels. R_{red}(i) is the reduced data rate of the i^{th} terminal, which is the highest data rate lower than its latest data rate and not lower than R_{minTFC}. When resources taken into a non-serving base station from a terminal in soft handover are computed, one approach is to account for the rate that has been transmitted in the terminal's previous HARQ process. It will be obvious to a person skilled in the art that as the technology advances, other approaches to estimating resources taken into a non-serving base station can be utilized in the invention.

As illustrated in step 204, data packets are scheduled so as to optimize resource allocation. In one embodiment this means that throughput, that is, the total amount of data transmitted on the uplink in the network, and fairness are optimized.

The rate control algorithm has two major characteristics, that is, prioritization of UE requests and controlling rate for maximum capacity utilization. A right to change or keep the data rates on the uplink is first granted to the UE having the highest priority, then successively to lower priority UE. The UE are assigned the TFC (Transport Format Combination) allowed in TFCS (Transport Format Combination Set) based on its request and available capacity.

Upon the initialization of the algorithm, the UE requests are prioritized according to a priority function, that is, associated with each UE is a priority count PRIORITY. PRIORITY of UE is initialized to 0 at the beginning of the algorithm. When new UE enters the system with cell j as the primary cell, or its buffer becomes non-empty after being idle due to lack of data, its PRIORITY is set to a minimum value.

In the algorithm, an index k is set to 1 and the rate Rₖ of the UE at the k^{th} position in the queue, according to three kinds of data rate requests (UP, KEEP and DOWN), is controlled as follows.

If the data rate request is “UP” and formula (6) applies, then the rate control bit is “UP”.

$${C}_{available} ( j ) - \frac{Sin {rT}_{k , j} ( {R}_{inc} ( k ) ) \cdot ( 1 + {\sum }_{ l } {PT}_{k , l} ( {R}_{inc} ( k ) ) )}{1 + Sin {rT}_{k , j} ( {R}_{inc} ( k ) ) \cdot ( 1 + {\sum }_{l} {PT}_{k , l} ( {R}_{inc} ( k ) ) )} + \frac{Sin {rT}_{k , j} ( {R}_{red} ( k ) ) \cdot ( 1 + {\sum }_{ l } {PT}_{k , l} ( {R}_{red} ( k ) ) )}{1 + Sin {rT}_{k , j} ( {R}_{red} ( k ) ) \cdot ( 1 + {\sum }_{l} {PT}_{k , l} ( {R}_{red} ( k ) ) )} \geq 0 \qquad ( 6 )$$

where R_{red}(k) is the reduced data rate of the k^{th} terminal, which is the lowest data rate higher than its latest data rate and not higher than the supportable maximum data rate. Otherwise, if the data rate request is “UP” and formula (7) applies, the rate control bit is “KEEP”.

$${C}_{available} ( j ) - \frac{Sin {rT}_{k , j} ( {R}_{latest} ( k ) ) \cdot ( 1 + {\sum }_{ l } {PT}_{k , l} ( {R}_{latest} ( k ) ) )}{1 + Sin {rT}_{k , j} ( {R}_{latest} ( k ) ) \cdot ( 1 + {\sum }_{l} {PT}_{k , l} ( {R}_{latest} ( k ) ) )} + \frac{Sin {rT}_{k , j} ( {R}_{red} ( k ) ) \cdot ( 1 + {\sum }_{ l } {PT}_{k , l} ( {R}_{red} ( k ) ) )}{1 + Sin {rT}_{k , j} ( {R}_{red} ( k ) ) \cdot ( 1 + {\sum }_{l} {PT}_{k , l} ( {R}_{red} ( k ) ) )} \geq 0 \qquad ( 7 )$$
where Rₗₐₛₜₑₛₜ(k) is the latest data rate of the k^{th} terminal. Otherwise, if the data rate request is “KEEP” and formula (8) applies, the rate control bit is “KEEP”.

$${C}_{available} ( j ) - \frac{Sin {rT}_{k , j} ( {R}_{latest} ( k ) ) \cdot ( 1 + {\sum }_{ l } {PT}_{k , l} ( {R}_{latest} ( k ) ) )}{1 + Sin {rT}_{k , j} ( {R}_{latest} ( k ) ) \cdot ( 1 + {\sum }_{l} {PT}_{k , l} ( {R}_{latest} ( k ) ) )} + \frac{Sin {rT}_{k , j} ( {R}_{red} ( k ) ) \cdot ( 1 + {\sum }_{ l } {PT}_{k , l} ( {R}_{red} ( k ) ) )}{1 + Sin {rT}_{k , j} ( {R}_{red} ( k ) ) \cdot ( 1 + {\sum }_{l} {PT}_{k , l} ( {R}_{red} ( k ) ) )} \geq 0 \qquad ( 8 )$$

Otherwise the rate control bit is “DOWN”.

If rate control is for a HARQ process, the rate controller controls the rate Rₖ as determined above if there is no retransmission, and otherwise, Rₖ is set to the corresponding previous transmission rate or is determined otherwise.

The available capacity is updated as shown by formula (9).

$${C}_{available} ( j ) = {C}_{available} ( j ) - \frac{Sin {rT}_{k , j} ( {R}_{k} ) \cdot ( 1 + {\sum }_{ l } {PT}_{k , l} ( {R}_{k} ) )}{1 + Sin {rT}_{k , j} ( {R}_{k} ) \cdot ( 1 + {\sum }_{l} {PT}_{k , l} ( {R}_{k} ) )} + \frac{Sin {rT}_{k , j} ( {R}_{red} ( k ) ) \cdot ( 1 + {\sum }_{ l } {PT}_{k , l} ( {R}_{red} ( k ) ) )}{1 + Sin {rT}_{k , j} ( {R}_{red} ( k ) ) \cdot ( 1 + {\sum }_{l} {PT}_{k , l} ( {R}_{red} ( k ) ) )} \qquad ( 9 )$$

j is the rate controlling sector
   where Rₖ is the data rate of the k^{th} user that is assigned by its rate control bit.

Next, a new PRIORITY for the k^{th} user is calculated. Then the next user is handled and when all users have been gone through, the process can be stopped.

It will be obvious to a person skilled in the art that the invention can also be applied to a system with two data rate requests, i.e., “UP” and “DOWN”.

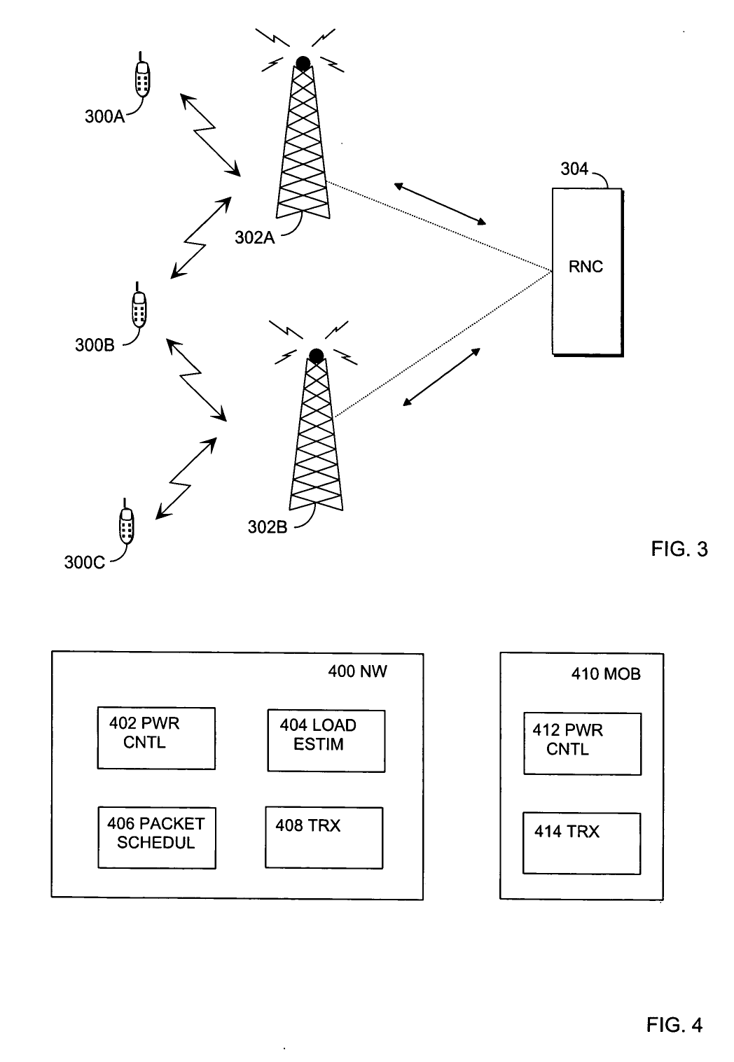

FIG. 3 shows one example of an arrangement according to the invention. In FIG. 3, terminals 300A to 300C have a packet data radio connection with base stations 302A and 302B of the network. The terminal 300B is illustrated to have a simultaneous connection with both of the base stations 302A, 302B, thereby being in soft handover. The base stations are connected to and controlled by a radio network controller 304. FIG. 3 shows two-head arrows between the base stations and the terminals, the arrows indicating that packet data is transmitted from the terminal to the base station. A base station performs packet scheduling and subsequently transmits packet allocation instructions to the terminals.

FIG. 4 illustrates a simplified block diagram of functional elements in the arrangement. A network 400 comprises a power controller 402 that can perform functions, such as setting quality target values, measuring the quality values on connections, comparing a quality target to measured quality and transmitting power up/down commands to the terminals. Load estimator/controller 404 estimates load of the network by using quality target values of connections, for instance. Packet scheduler 406 decides, based on the load information, how uplink capacity is allocated to different connections. The packet scheduler can also be responsible for receiving quality reports from base stations so as to optimize radio resource allocation from the network. Furthermore, the scheduler can decide about retransmissions of packets. A transceiver 408 residing in a base station is responsible for implementing a bi-directional radio connection to a terminal, such as a mobile phone. The terminal 410 comprises a transceiver having a functionality corresponding to the one of the transceiver 408 in the network. Power controller 412 sets the transmission power of the terminal 410 in response to power up/down commands received from the network.

The invention can be implemented by software, by ASIC (Application Specific Integrated Circuit, by separate logic components or in another manner.

It will be obvious to a person skilled in the art that as technology advances, the inventive concept can be implemented in various ways. The invention and its embodiments are not limited to the examples described above but may vary within the scope of the claims.

1. An uplink scheduling method in a mobile communication network, wherein at least one mobile terminal has at least one uplink packet data connection with the mobile communication network, the method comprising:
forming a quality target for each uplink packet data connection;
estimating a load of a network element by applying the formed quality target;
scheduling uplink data packets to be sent by the at least one mobile terminal by monitoring that the estimated load does not exceed a predetermined load threshold of the network element.

2. A method according to claim 1, wherein
the estimated load of the network element is estimated by using the quality targets for all uplink connections supported by the network element at a certain moment.

3. A method according to claim 1, wherein the step of scheduling comprises scheduling uplink data packets to be sent by the at least one mobile terminal by monitoring that an estimated load does not exceed a predetermined load threshold of a base station.

4. A method according to claim 3, wherein:
the estimated load of the base station is estimated for such connections for which the base station is a serving base station.

5. A method according to claim 1, wherein the step of scheduling comprises scheduling uplink data packets to be sent by the at least one mobile terminal by monitoring that an estimated load does not exceed a predetermined load threshold of a base station controller.

6. A method according to claim 1, the method further comprising:
setting a quality target for a connection;
measuring received quality on a connection between a terminal and the mobile communication network;
adjusting transmitting power of the terminal based on a difference between the quality target and a measured quality.

7. A method according to claim 1, the method further comprising:
reporting a quality of a connection;
adjusting the quality target on the basis of the reported quality.

8. A method according to claim 1, the method further comprising:
retransmitting, from the at least one mobile terminal, an initial data frame that is not accepted by the mobile communication network;
setting, for a retransmitted frame, a quality target different from the quality target of the initial frame.

9. A mobile communication network including:
at least one base station for supporting at least one uplink packet data connection of at least one terminal that is in an audibility area of the at least one base station;
means for forming a quality target for each uplink connection;
means for estimating a load of a network element by applying the formed quality target;
means for scheduling uplink data packets to be sent by the at least one terminal by monitoring that the estimated load does not exceed a predetermined load threshold of the network element.

10. The mobile communication network of claim 9, wherein the estimating means are configured to calculate the estimated load of the network element by using the quality targets for all uplink packet data connections served by the network element at a certain moment.

11. The mobile communication network of claim 9, wherein the network element is a base station.

12. The mobile communication network of claim 11, wherein:
the estimating means are configured to calculate load of the base station for such connections, for which the base station is a serving base station.

13. The mobile communication network of claim 9, wherein the network element is a base station controller.

14. The mobile communication network of claim 9, wherein the mobile communication network comprises:
means for setting the quality target for a connection;
means for measuring quality on a connection between a terminal and the mobile communication network;
means for adjusting transmitting power of the terminal based on a difference between the quality target and the measured quality.

15. The mobile communication network of claim 9, wherein the mobile communication network comprises:
means for reporting quality of a connection;
means for adjusting the quality target on the basis of the reported quality.

16. The mobile communication network of claim 9, wherein the mobile communication network comprises:
means for retransmitting, from the at least one terminal, an initial data frame that is not accepted by the mobile communication network;
means for setting, for a retransmitted frame, a different quality target in comparison to the quality target of the initial frame.
